(19) United States
(12) Patent Application Publication
(10) Pub. No.: US 2008/0231161 A1
(43) Pub. Date: Sep. 25, 2008

(54) Low-Mercury-Consuming Fluorescent Lamps with Phosphor/Alumina-Containing Layer

(75) Inventors: A. Gary Sigai, Salina, KS (US); Charles Joseph Trushell, Manhattan, KS (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,348

(22) PCT Filed: Sep. 19, 2006
(86) PCT No.: PCT/IB06/53376

§ 371 Date: Mar. 19, 2008

Related U.S. Application Data
(60) Provisional application No. 60/720,594, filed on Sep. 26, 2005.

(51) Int. Cl. H01J 63/04; H01J 9/02

(52) U.S. Cl. 313/486; 445/26

(57) ABSTRACT

A low-mercury-consuming fluorescent lamp (1) contains a fine particle size alpha alumina in the phosphor-containing layer (16) on the inner surface (15) of the lamp envelope (3). The lamp envelope (3) may have one or more bends (22), in which case the phosphor-containing layer (16) additionally contains an adhesive, such as a borate adhesive, to enhance adhesion, especially in the bend areas. The phosphor-containing layer (16) may be formed from a water-based coating suspension to which the fine particle alpha alumina is added after its pre-dispersion in deionized water.

This invention relates to low pressure mercury vapor discharge fluorescent lamps, and more particularly relates to such lamps which are low-mercury-consuming.

Low pressure mercury vapor discharge lamps, more commonly known as fluorescent lamps, have a lamp envelope with a filling of mercury and a rare gas to maintain a gas discharge during operation. The radiation emitted by the gas discharge is mostly in the ultraviolet (UV) region of the electromagnetic spectrum, with only a small portion in the visible region of the spectrum. The inner surface of the lamp envelope has one or more coatings containing one or more luminescent materials, commonly called phosphors, which emit visible light upon excitation by the ultraviolet radiation.

There is an increased desire for fluorescent lamps to be more efficient (to have higher luminous efficacy) and to have longer operating life. A major determinant of longer life is the amount of excess mercury present in the lamps beyond that required to support the discharge. Excess mercury is necessary because different lamp components, such as the glass envelope, the phosphor coatings and the electrodes use up the mercury which would otherwise be available to generate ultraviolet radiation. However, the increased use and eventual disposal of mercury is costly and potentially detrimental to the environment. Accordingly, there is a drive to reduce mercury consumption in fluorescent lamps without an accompanying reduction in the operating life of the lamp.

One example of a commercially successful low-mercury-consuming fluorescent lamp is the 34 watt T12 Econowatt® U-bend fluorescent lamp that is currently being manufactured with a single coating of a 50/50 wt. % blend of a standard-particle-sized halophosphate phosphor (called ‘regular’ halophosphor) and a small-particle-sized halophosphate phosphor (called halophosphor ‘fines’). The fines are typically produced as a by-product of the production of the regular halophosphor. The regular halophosphor has been described in detail in U.S. Patent Application Ser. No. 60/623,747, Attorney Docket No. PHUS040439, filed Oct. 29, 2004.

While the original purpose of the halophosphor fines was to improve adhesion of the coating during and after formation of the U-bend of the lamp, we discovered that they play an essential role in mercury consumption, and in particular, that the amount of the ‘superfines’ fraction of the fines is critical for low mercury consumption. See, for example, the above-referenced U.S. Patent Application Ser. No. 60/623,747, the entire specification of which is incorporated herein by reference.

Unfortunately, since such fines are a by-product of the production of regular halophosphor, it is often difficult, if not impossible, to accurately control the particle size distribution to meet specific target specifications that may be required. Moreover, such fines amount to only about 2 to 12 weight percent of the production volume, depending on the final specific separation process used by the manufacturer.

Further, with the industry trend away from halophosphor lamps to high color rendering lamps that typically contain primarily only triband rare-earth phosphors (a blend of three different rare earth phosphors emitting red, green and blue light), the amount of halophosphor fines available for the manufacture of U-bend lamps is decreasing. Therefore, the need for a suitable replacement for the halophosphor fines is desirable. Further, it is desirable to have a replacement that is available in sufficient quantities and consistent quality.

Another approach to achieving low mercury consumption in fluorescent lamps is described in U.S. Pat. No. 6,369,502. In this patent, a low pressure mercury vapor discharge lamp is described having a single coating of halophosphor mixed with 5-30 mass % aluminum oxide having a primary particle size below 30 nanometers (0.03 microns). This aluminum oxide is said to be mainly the gamma form, with some of the delta and/or beta forms optionally mixed in. Among the advantages claimed is that the quantity of mercury to be dosed into the lamp is decreased.

U.S. Pat. No. 6,528,938 describes a mercury vapor discharge fluorescent lamp having a single composite phosphor-containing layer, the layer being a heterogeneous mixture of halophosphors, rare earth triphosphors and from 0.05-40 wt. %, e.g., 5 wt. %, colloidal alumina particles. The colloidal alumina particles are said to range in size from 10-1000 nanometers (0.01-1.0 microns), e.g., 50-100 nanometers (0.05-0.1 microns) and to be uniformly size distributed throughout the phosphor-containing layer. The advantages claimed are that the colloidal alumina particles minimize UV emission from the lamp by beneficially reflecting UV radiation toward the phosphor particles where it may be utilized for more efficient production of visible light, thus eliminating the need for a separately applied alumina layer as is conventional in the prior art.

It is an object of the invention to provide a low-mercury-consuming fluorescent lamp which does not rely on the use of halophosphor fines to achieve low mercury consumption.

It is another object of the invention to provide a suitable replacement for the halophosphor fines that is readily available in sufficient quantity and of consistent quality.

According to one aspect of the invention, a low-mercury-consuming fluorescent lamp having at least one phosphor-containing layer is characterized in that the layer also contains a fine particle alpha alumina, having a specific surface area of about 4-8 meters squared per gram (M²/gm), preferably 5-7 meters squared per gram (M²/gm), and a primary particle size of about 0.20-0.30 microns.

Such a fine particle alumina having a specific surface area of about 6 meters squared per gram (M²/gm) and a primary particle size of about 0.25 microns, is preferred. Such a fine particle alumina is manufactured under tight control and is readily available from the firm of Baikowski under the tradename Baikalox with a product code of CR6. This material is reported as consisting of about 97% alpha alumina with the balance being primarily other trace alumina components such as gamma alumina, for example.

We have found through testing that mercury depletion in halophosphor fluorescent lamps is inversely proportional to the amount of such a fine particle alpha alumina which is present in the phosphor-containing layer. Since such fine particle alpha alumina is a non-luminescent material, one would expect that lumen output from a lamp would decrease linearly as a function of increasing amounts of alpha alumina. However, we have unexpectedly found that a much smaller reduction in lumen output occurs. For example, in the case of a 15 wt. % alpha alumina addition, we found only a 2-3% reduction in lumen output, making it possible to substitute such fine particle alpha alumina for halophosphor fines to achieve low-mercury-consuming halophosphor fluorescent lamps of sufficient brightness for EPACT (Energy Policy Act) compliance.

Moreover, we have found that such fine particle alpha alumina is more effective in reducing mercury consumption than halophosphor fines, making it possible to substitute smaller amounts of such fine particle alpha alumina for halophosphor fines to achieve low-mercury-consuming fluorescent lamps. For example, the 15 wt. % alpha alumina addition is comparable in effectiveness to a 50 wt. % halophosphate fines addition for achieving low mercury consumption.

Moreover, since alpha alumina is not a luminescent material, it can be used as a universal substitute for all colors of halophosphor (e.g., cool-white, warm-white, daylight, etc.) whereas the fines used in the current halophosphor lamps are luminescent and thus must be color-matched to the specific lamps being manufactured. This interchangeability and lower percentage usage assist in all aspects of the logistics (i.e., ordering, storing, usage, etc.)

Also, fine particle alpha alumina is a more chemically inert material than are halophosphate fines.

Such a low-mercury-consuming fluorescent lamp in accordance with the invention comprises:

a lamp envelope having an inner surface;

a fill of mercury and a rare gas within the lamp envelope; and

at least one phosphor-containing layer on the inner surface;

characterized in that the phosphor-containing layer also contains a fine particle alpha alumina, a specific surface area in the range of about 4-8 meters squared per gram (M²/gm), more preferably 5-7 meters squared per gram (M²/gm), and most preferably about 6 meters squared per gram (M²/gm) and a primary particle size in the range of about 0.20-0.30 microns, preferably about 0.25 microns.

In accordance with a preferred embodiment of the invention, the lamp envelope comprises an elongated tube having one or more bends, for example, a U-bend or circular bend such as in the Circleline® design, and the phosphor-containing layer additionally contains an adhesive for enhancing the adhesion of the layer to the inner surface of the envelope, most particularly for the bend area(s).

In accordance with a particularly preferred embodiment of the invention, the lamp envelope includes a U-bend or circular bend such as in the Circleline® lamp, the phosphor contained in the layer is a halophosphor, the alumina is present in the amount of from 10 to 20 wt. %, and the adhesive is a borate and is present in the amount of about 0.75 to 1.6 wt. %.

According to another aspect of the invention, a method of producing the phosphor-containing layer for lamps of the invention is provided, the method comprising the steps of:
(a) forming a water-based coating suspension of the phosphor;
(b) pre-dispersing the fine particle alpha alumina in deionized (DI) water; and
(c) adding the pre-dispersion of fine particle alpha alumina to the coating suspension; and
(d) applying the coating suspension to the inner surface of the lamp envelope.

In accordance with a preferred embodiment of the method of the invention, a borate adhesive is added to the water-based coating suspension prior to applying the coating suspension to the inner surface of the lamp envelope. Following application of the coating suspension containing the alumina and the borate adhesive, the lamp envelope may be heated and formed into the desired shape. During such heating and forming, the borate adhesive enhances the adhesion of the phosphor-containing layer, particularly in the bend area(s).

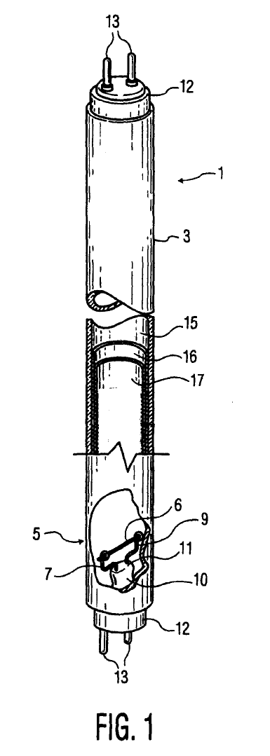

FIG. 1 is a plan view of one embodiment of a fluorescent lamp according to one embodiment of the invention, partly in cross-section, partly broken away;

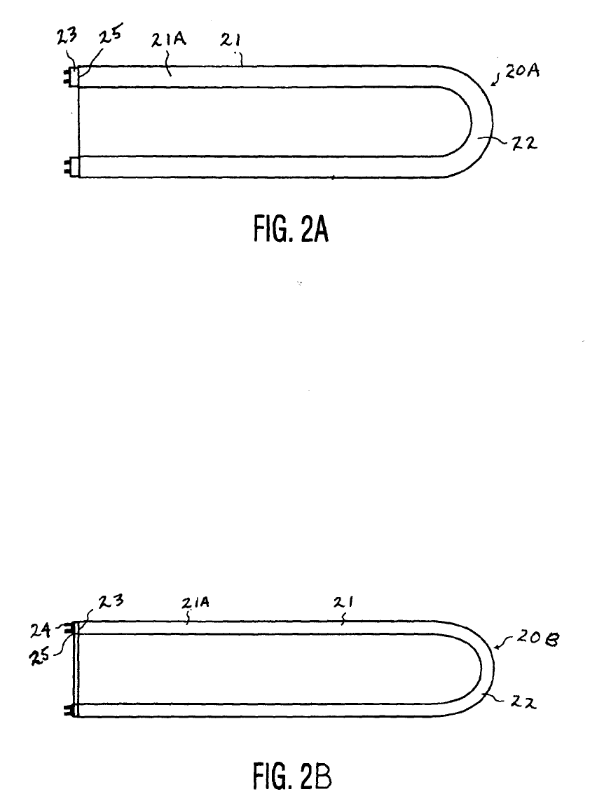

FIGS. 2A and 2B are plan views of U-bend fluorescent lamps according to other embodiments of the invention;

FIGS. 2C and 2D are plan views of Circleline® fluorescent lamps having envelopes of convoluted circular configurations according to still other embodiments of the invention;

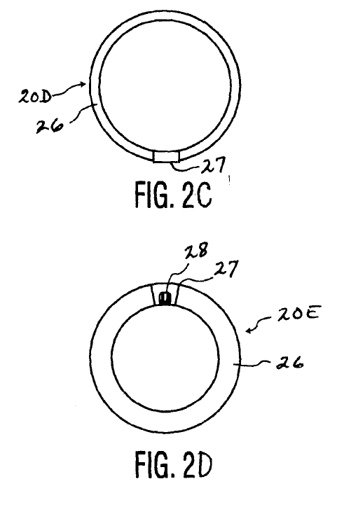

FIG. 3 is a graph illustrating the mercury consumption expressed as time to depletion (hrs) as a function of fine particle alumina concentration (wt. %); and

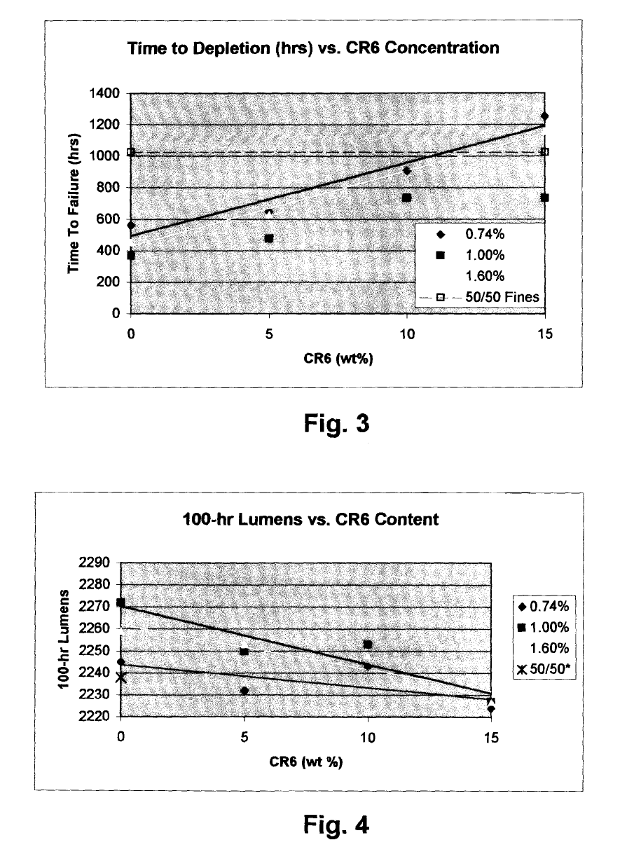

FIG. 4 is a graph illustrating lumen output expressed as 100-hr lumens as a function of fine particle alpha alumina concentration (wt. %).

The invention will be described in terms of specific embodiments with reference to these figures. The figures are diagrammatic and not to scale.

FIG. 1 illustrates a low pressure mercury vapor discharge fluorescent lamp 1 with an elongated glass envelope 3 of a type similar to an FB40T12 lamp.

The envelope is of a conventional soda-lime glass. The lamp includes an electrode mount structure 5 at each end of the envelope 3 which includes a coiled tungsten filament 6 supported on conductive feed-throughs 7 and 9, which extend through a glass press seal 11 in a mount stem 10. The mount stem 10, of a conventional lead-containing glass, seals the envelope 3 in a gas tight manner. Bases 12, fixed at opposite ends of the lamp envelope 3, each have pin-shaped contacts 13, to which the leads 7, 9 are connected.

A halophosphor-containing layer 16 also contains a fraction of fine particle alpha alumina as described above. Layer 16 is disposed on the inner surface 15 of the envelope 3. Optionally, particularly in the case of U-bend lamps or lamps of convoluted configuration as illustrated in FIGS. 2A-2D, layer 16 additionally includes a borate material for enhancing adhesion between the lamp surface and the phosphor-containing layer in the bend area. Optionally, also, if desired, a second phosphor-containing layer 17 is disposed over the halophosphor layer 16. Layer 17 may contain for example at least one rare earth phosphor or rare earth blend of phosphors such as a triphosphor blend. The phosphor layers 16 and 17 extend the full length of the envelope 3, completely circumferentially around the envelope inner wall.

The discharge-sustaining fill typically includes an inert gas such as argon, or a mixture of argon and other gases, at a low pressure in combination with a quantity of mercury sufficient to sustain an arc discharge during lamp operation.

The lamps shown in FIGS. 2A and 2B are U-bend fluorescent lamps similar to the FB40T12/6 and FB32T8/6 lamps, respectively. Similar features are indicated with the same reference numerals. Lamps 20A and 20B each have a glass envelope 21 consisting of an elongated tube 21A with a bend region 22. The ends of the tubes are capped with bases 23, through which extend connector pins 24. A bracing member 25 extends between the bases 23.

The lamps shown in FIGS. 2C and 2D are circular fluorescent lamps similar to the Circleline® FC12T5 and FC12T9, respectively. Lamps 20C and 20D each have a tubular glass envelope 26 which has been formed into a circle. The ends of the tubes are joined by a joining member 27, through which extend connector pins 28.

The U-bend lamp is fabricated by first coating the glass tube with a phosphor coating suspension. Then the lamp is lehred to bake out the binder, and finally the lehred lamp is heated and bent to form the U-bend geometry. In order to make the phosphor coating adhere to the lamp, especially in the bend areas, a borate adhesive is added to the suspension. Preferably, the borate adhesive concentration as residual material after baking is 0.76 wt. %. This weight percentage of borate adhesive is with respect to the weight of phosphor.

To demonstrate the advantages of the invention, a series of FB 34-watt T12 TLU Econowatt lamps® were fabricated with a single halophosphor coating layer containing various percentages of CR6 alumina. To promote adhesion, especially during the bending process, the borate adhesive was added to the coating.

Coating Suspension Formulations

A water-based coating suspension of regular halophosphate phosphor and CR6 fine particle alumina was prepared, the relative amount of CR6 ranging from 0-15 wt. % (0, 5, 10, and 15 wt. %), with the remainder being regular halophosphate phosphor.

CR6 fine particle alpha alumina was pre-dispersed in DI water prior to incorporation into the suspension. To this suspension was added borate adhesive components in amounts sufficient to result in borate adhesive in residue weights of 0.76%, 1.00% and 1.60%, respectively.

Single-coat 34-watt T12 Econowatt® U-bend (FB34T12CW/EW) lamps incorporating coatings with the various amounts of the CR6 and borate adhesive described above, as well as control lamps with coatings having 50/50 wt. % regular/fines halophosphor with 0.76 wt. % borate, were fabricated and tested for lumen performance and coating adhesion according to standard techniques. Additional production lamps having the same coatings as the fabricated control lamps were pulled from regular production runs and were also tested.

Additional FB34T12CW/EW lamps were fabricated corresponding to all of the 14 previous test groups, but with capsules filled with 1 mg of mercury to evaluate time to depletion.

Mercury Consumption.

Mercury consumption was evaluated by measuring time to depletion for the 1-mg-Hg lamps, i.e., the time required for a lamp to dim in brightness due to almost complete consumption of the mercury by the lamp components, indicating that no free mercury remains to sustain the lamp discharge. Time to depletion for the tested lamps is plotted in hrs. as a function of CR6 concentration for various borate adhesive concentrations in FIG. 3.

The data show that the depletion time is directly proportional to the CR6 content, ranging from about 400 hrs up to about 1200 hrs—indicating a threefold increase in life. (The lower life at 1.00% borate concentration and 15% CR6 should be discounted since only one lamp of this composition survived processing and since it does not fit the trend of other lamp groups). The 1,000-hr depletion time for the 50/50 composition control is in excellent agreement with the historical value for this lamp type at 1,000 hrs of burning. The depletion time for borate compositions that match the 50/50 control occurs at about 12% CR6. These data show that CR6 is a substitute for the currently used halophosphate fines phosphor.

Lumen Performance.

The 0-hr lumens, 100-hr lumens and 100-hr lumens per watt (lpw) values are tabulated for the tested lamps in Table I.

TABLE I
The dependence of 100-hr lumens is also displayed as a function of CR6 concentration

| | Borate | | | | | | | | |
|---|---|---|---|---|---|---|---|---|---|
| | 0.74% | | | 1.00% | | | 1.60% | | |
| CR6 (wt %) | 0-hr Lumens | 100-hr Lumens | 100-hr lpw | 0-hr Lumens | 100-hr Lumens | 100-hr lpw | 0-hr Lumens | 100-hr Lumens | 100-hr lpw |
| 0 | 2343 | 2245 | 65.8 | 2387 | 2272 | 65.5 | 2368 | 2259 | 65.7 |
| 5 | 2335 | 2232 | 65.5 | 2360 | 2250 | 66.2 | 2340 | 2253 | 65.8 |
| 10 | 2334 | 2242 | 65.8 | 2348 | 2253 | 65.6 | 2332 | 2248 | 65.9 |
| 15 | 2295 | 2224 | 65.1 | 2304 | 2227 | 65.2 | 2305 | 2227 | 65.3 |
| 50/50* | 2321 | 2238 | 65.7 | | | | | | |
| Production | 2329 | 2257 | 66.3 | | | | | | |

EPACT requires 100-hr lpw: 640
all compositions meet EPACT
*50/50 Regular/Fines as a Control

for each of the borate sets in FIG. 4. The 100-hr lumens show up to about a 2-3% decrease in output from the control and production lamps for the additions of up to 15% CR6, which is substantially less than would be anticipated. All of the lamps met the EPACT (Energy Policy Act) minimum requirement of 100-hr 64.0 lpw.

Adhesion.

The tested lamps were examined in the bend area for loss of coating. The scoring criteria established to rate these lamps are given in Table II along with the summary of the findings. A ‘0’ indicates that no powder was lost from the coating in the bend area. A ‘−1’ indicates that a slight amount of powder was lost. A ‘−2’ score was selected if there was a substantial amount of powder lost. In no cases were lamps observed with substantial amounts of powder lost from the bend area. The intermediate values such as ‘−0.43’ result from an arithmetic average of all the lamps in the test group, typically between 4 and 7 lamps.

TABLE II

| | 0.74% | | 1.00% | | 1.60% | |
|---|---|---|---|---|---|---|
| | | Adhe- | | Adhe- | | Adhe- |
| CR6 (wt %) | Group | sion | Group | sion | Group | sion |
| 0 | AA | −0.43 | AB | 0.00 | AC | 0.00 |
| 5 | BA | −0.43 | BB | −1.00 | BC | −0.50 |
| 10 | CA | −1.00 | CB | −1.00 | CC | −0.14 |
| 15 | DA | −1.00 | DB | −0.71 | DC | 0.00 |
| 50/50 | L | −0.83 | | | | |
| Pro- | R | 0.00 | | | | |
| duction | | | | | | |

| Criteria | Relative Scoring |
|---|---|
| no powder loss in bends | 0 |
| some powder loss in bends | −1 |
| significant powder loss in bends | −2 |

The data summarized in Table II indicates the best adhesion is for compositions with the highest borate concentrations (1.60 wt. %.) For lower concentrations, some loss of powder in the bend area was routinely seen. Further, with increased amounts of CR6 addition, the adhesion appears to deteriorate to unacceptable levels without a corresponding increase in borate concentration. This is probably due to the major increase in surface area of the powder mixture with CR6 addition.

Based on lamp testing, the single-coat FB34-watt T12 Econowatt U-bend lamp can be produced with the use of CR6 fine particle alpha alumina as a substitute for the currently used halophosphor fines. Lamps so made have low mercury consumption, good lumen performance that meets or exceeds minimum requirements of EPACT, and good coating adhesion, to allow the manufacture of lamps of the ALTO variety. CR6 is a viable replacement for halophosphor fines for all halophosphor colors (cool-white, warm-white, daylight, etc.) in single coat U-bend lamps, as well as in other lamp geometries, and in double-coat lamps, e.g., lamps in which the base coat is a halophosphor layer and the top coat is a triphosphor layer. These are, for example, the FB32T8 U-bend T8 lamps.

Lamps incorporating phosphors other than halophosphates can also benefit from the invention, such as strontium pyrophosphate:Sn (blue emission) and strontium magnesium orthophosphate:Sn (orange emission) phosphors.

The embodiments and examples set forth herein are presented to explain the present invention and its practical application and to thereby enable those skilled in the art to make and utilize the invention. Those skilled in the art, however, will recognize that the foregoing description and examples have been presented for the purpose of illustration and example only. Other embodiments, variations of embodiments, and equivalents, as well as other aspect, objects, and advantages of the invention, will be apparent to those skilled in the art. Thus, the principles of the present invention can be obtained from a study of the drawings, the disclosure, and the appended claims.

1. A low-mercury-consuming fluorescent lamp (1) comprising:
a lamp envelope (3) having an inner surface (15);
a fill of mercury and a rare gas within the lamp envelope; and
at least one phosphor-containing layer (16) on the inner surface (15), the layer (16) containing at least one phosphor;
characterized in that the phosphor-containing layer (16) also contains a fine particle alpha alumina having a specific surface area in the range of about 4-8 meters squared per gram (M²/gm) and a primary particle size in the range of about 0.20-0.30 microns.

2. The low-mercury-consuming fluorescent lamp (1) of claim 1 in which the fine particle alpha alumina has a specific surface area of about 5-7 meters squared per gram (M²/gm) and a primary particle size of about 0.25 microns.

3. The low-mercury-consuming fluorescent lamp (1) of claim 1 in which the fine particle alpha alumina is present in the phosphor-containing layer in the amount of from about 10 to 20 weight percent.

4. The low-mercury-consuming fluorescent lamp (1) of claim 1 in which the fine particle alpha alumina is present in the phosphor-containing layer in the amount of about 15 weight percent.

5. The low-mercury-consuming fluorescent lamp (20A, 20B, 20C, 20D) of claim 1 in which the lamp envelope (21) comprises an elongated tube having one or more bends (22, 26).

6. The low-mercury-consuming fluorescent lamp (20A, 20B) of claim 5 in which the one or more bends comprises a U-bend (22).

7. The low-mercury-consuming fluorescent lamp (20C, 20D) of claim 5 in which the one or more bends comprises a circular bend (26).

8. The low-mercury-consuming fluorescent lamp (20A, 20B, 20C, 20D) of claim 5 in which the phosphor-containing layer (16) additionally contains an adhesive for enhancing the adhesion of the layer (16) to the inner surface (15) of the envelope (21).

9. The low-mercury-consuming fluorescent lamp (20A, 20B, 20C, 20D) of claim 8 in which the adhesive comprises a borate adhesive.

10. The low-mercury-consuming fluorescent lamp (20A, 20B, 20C, 20D) of claim 9 in which the borate adhesive is present in the phosphor-containing layer in the amount of from about 0.75 to about 1.6 weight percent.

11. The low-mercury-consuming fluorescent lamp (1) of claim 1 in which the phosphor-containing layer (16) contains at least one halophosphate phosphor.

12. The low-mercury-consuming fluorescent lamp (1) of claim 1 in which a second phosphor-containing layer (17) is disposed over the phosphor-containing layer (16).

13. The low-mercury-consuming fluorescent lamp (1) of claim 12 in which the second phosphor-containing layer (17) contains at least one rare earth phosphor.

14. A method for producing a phosphor/alumina-containing layer (16) on the inner surface (15) of the envelope (3) of a low-mercury-consuming fluorescent lamp (1), the method comprising the steps of:
(a) forming a water-based coating suspension of the phosphor;
(b) pre-dispersing a fine particle alpha alumina in deionized (DI) water;
(c) adding the pre-dispersion of fine particle alpha alumina to the coating suspension; and
(d) applying the coating suspension to the inner surface of the lamp envelope.

15. The method of claim 14 in which a borate adhesive components are added to the water-based coating suspension prior to applying the coating suspension to the inner surface of the lamp envelope.

16. The method of claim 15 in which following application of the coating suspension containing the alumina and the borate adhesive, the lamp envelope is heated and formed into a desired shape.

17. The method of claim 16 in which the lamp envelope is formed into a shape having a U-bend.

18. The method of claim 16 in which the lamp envelope is formed into a shape having a circular bend.
